(19) United States
(12) Patent Application Publication
(10) Pub. No.: US 2025/0086501 A1
(43) Pub. Date: Mar. 13, 2025

(54) DATA IMPUTATION OF UNKNOWN-UNKNOWN DATA AND USE THEREOF

(71) Applicant: Optum, Inc., Minnetonka, MN (US)

(72) Inventors: Robert Elliott TILLMAN, Long Island City, NY (US); Sanjit Singh BATRA, Redwood City, CA (US); Josue NASSAR, Syosset, NY (US); Jun HAN, Union City, NJ (US); Eran HALPERIN, Santa Monica, CA (US); Brian Lawrence HILL, Culver City, CA (US); Vijay S. NORI, Roswell, GA (US)

(21) Appl. No.: 18/541,768

(22) Filed: Dec. 15, 2023

Related U.S. Application Data
(60) Provisional application No. 63/582,121, filed on Sep. 12, 2023.

(51) Int. Cl. G06N 20/00

(52) U.S. Cl. CPC G06N 20/00

(57) ABSTRACT

Embodiments of the present disclosure provide for improved data imputation and use of imputed data in processing of downstream models. Some embodiments specially train a model that performs improved data imputation utilizing a specially-configured attention mechanism. Some embodiments train a model utilizing stratified masking. Some embodiments train a particular pre-processing layer of a downstream task-specific model to adaptively learn threshold values for imputing particular data. The pre-processing layer is usable to improve accuracy training and/or use of a downstream task-specific model based at least in part on the imputed data.

### CROSS-REFERENCE TO RELATED APPLICATIONS

This application claims priority to U.S. Provisional App. No. 63/582,121 titled “APPARATUSES, COMPUTER-IMPLEMENTED METHODS, AND COMPUTER PROGRAM PRODUCTS FOR IMPROVED DATA IMPUTATION” filed Sep. 12, 2023, the contents of which are incorporated by reference herein.

### TECHNICAL FIELD

Embodiments of the present disclosure generally relate to imputation of data, and specifically to imputation of unknown-unknown data values in a data set.

### BACKGROUND

In various contexts, a data set may suffer from missing particular data values. Such missing values may have impacts on configuring of machine learning models, as well as uses of such data in a downstream process. In some such contexts, however, it may be unknown from inspection of a data set whether a particular data value is correctly missing from the data set or appropriately not existing in the data set, such that the data set may include any number of unknown-unknown data values.

Applicant has discovered problems and/or inefficiencies with current implementations for data imputation and use of unknown-unknown data. Through applied effort, ingenuity, and innovation, Applicant has solved many of these identified problems by developing solutions embodied in the present disclosure, which are described in detail below.

### BRIEF SUMMARY

In general, various embodiments of the present disclosure provide methods, apparatuses, systems, computing devices, computing entities, and/or the like for performing improved data imputation and use of imputed data in downstream machine learning models.

In one aspect, a computer-implemented method includes identifying, by one or more processors, a truth source data set associated with a plurality of data parameters, generating, by the one or more processors, an updated truth source data set by augmenting the truth source data set utilizing a stratified masking algorithm that masks at least one data parameter from the truth source data set, generating, by the one or more processors and using a trained model that comprises at least one attention layer, a probability data set that comprises a particular probability that a particular data parameter should be present in the updated truth source data set; and generating, by the one or more processors and based at least in part on the probability data set, a probability threshold set corresponding to each data parameter represented in the probability data set.

The computer-implemented method may also include where generating, by the one or more processors, the probability threshold set includes training a task-specific model to generate at least the probability threshold set, where the task-specific model includes at least one pre-processing layer that learns a particular probability threshold for each data parameter of the plurality of data parameters.

The computer-implemented method may also include where identifying the truth source data set includes combining, by the one or more processors, a first set of data and a second set of data based at least in part on identifiers shared between the first set of data and the second set of data.

The computer-implemented method may also include further including training the trained model by at least applying at least a subset of the updated truth source data set corresponding to the particular identifier a transformer model.

The computer-implemented method may also include where the at least one attention layer includes a set attention block comprising a plurality of layers, where at least a subset of the updated truth source data set is processed via the plurality of layers of the set attention block, and where attention block output from the set attention block is provided to a parallel linear block that generates a tensor corresponding to the attention block output.

The computer-implemented method may also include further receiving, by the one or more processors, a second parameter data set and generating, by the one or more processors, task-specific results by applying the second parameter data set to a task-specific model trained based at least in part on the probability threshold set.

The computer-implemented method may also further include determining, by the one or more processors, that the particular probability corresponding to the particular data parameter satisfies the particular probability threshold corresponding to the particular data parameter, and in response to determining that the particular probability threshold is satisfied, skipping, by the one or more processors, updating of the updated probability data.

The computer-implemented method may also include further determining, by the one or more processors, that the particular probability corresponding to the particular data parameter does not satisfy the particular probability threshold corresponding to the particular data parameter, and generating, by the one or more processors, updated probability data corresponding to the particular probability threshold by updating the probability data corresponding to the particular probability threshold to zero in response to determining that the particular probability will not satisfy.

The computer-implemented method may also further include applying, by the one or more processors, a second data set to the task-specific model, where the task-specific model is configured to ignore at least one non-imputed data parameter based at least in part on the updated probability data.

The computer-implemented method may also include where the task-specific model is determined based at least in part on a machine learning task determined to be performed.

The computer-implemented method may also further include training, by the one or more processors, a second task-specific model to generate at least a second probability threshold set, where the second task-specific model includes at least one second pre-processing layer that learns a second particular probability threshold for each data parameter of the plurality of data parameters, and generating, by the one or more processors and based at least in part on the probability data set, the second probability threshold set corresponding to each data parameter represented in the probability data set.

The computer-implemented method may also include where the tensor is applied to a sigmoid activation function that outputs the probability that the particular data parameter should be present in the updated truth source data set for each data parameter of the any number of data parameters.

In accordance with another aspect of the disclosure, a system is provided that includes one or more processor and one or more memory having computer program code stored thereon that, in execution with the one or more processor, configures the system to perform any one of the example methods described herein.

In accordance with another aspect of the disclosure, a computer program product is provided that includes one or more non-transitory computer-readable storage medium having computer program code stored thereon that, in execution with at least one processor, configures the computer program product to perform any one of the example methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example computing system in accordance with at least one embodiment of the present disclosure.

FIG. 2 is a schematic diagram showing a system computing architecture 200 in accordance with at least one embodiment of the present disclosure.

FIG. 3 illustrates an example data flow for generation of an updated truth source data set to be processed in accordance with at least one embodiment of the present disclosure.

FIG. 4 illustrates an example data flow for generating a probability data set utilizing an imputation model in accordance with at least one embodiment of the present disclosure.

FIG. 5 illustrates an example data architecture of an imputation model utilizing a set attention block in accordance with at least one embodiment of the present disclosure.

FIG. 6 illustrates an example data architecture of training a task-specific model to generate at least the probability threshold set in accordance with at least one embodiment of the present disclosure.

FIG. 7 illustrates an example data architecture for updating a probability data set based at least in part on at least one probability threshold in accordance with at least one embodiment of the present disclosure.

FIG. 8 illustrates an example data flow for utilizing a trained task-specific model in accordance with at least one embodiment of the present disclosure.

FIG. 9 illustrates a flowchart depicting example operations of a process for generating and using a probability data set for data imputation in accordance with at least one embodiment of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specially-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

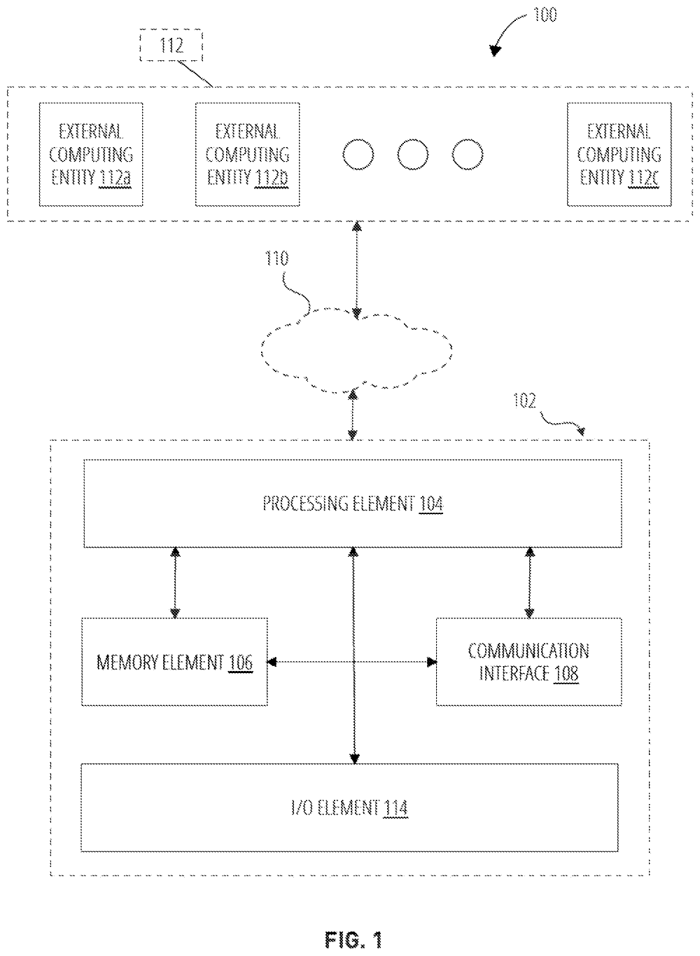

FIG. 1 illustrates an example computing system 100 in accordance with one or more embodiments of the present disclosure. The computing system 100 may include a modeling computing entity 102 and/or one or more external computing entities 112a-c communicatively coupled to the modeling computing entity 102 using one or more wired and/or wireless communication techniques. The modeling computing entity 102 may be specially configured to perform one or more steps/operations of one or more evaluation techniques described herein. In some embodiments, the modeling computing entity 102 may include and/or be in association with one or more mobile device(s), desktop computer(s), laptop(s), server(s), cloud computing platform(s), and/or the like. In some example embodiments, the modeling computing entity 102 may be configured to receive and/or transmit one or more data objects from and/or to the external computing entities 112a-c to perform one or more steps/operations for improved data imputation and/or downstream processing based at least in part on such data imputation as described herein. Non-limiting examples of the improved data imputation includes training and/or use of an imputation model, for example to generate a probability data set associated with a plurality of data parameters. Non-limiting downstream processing based at least in part on such data imputation includes processing of a probability data set for training a task-specific model including a pre-processing layer that defines a probability threshold set corresponding to the plurality of data parameters, and/or utilizing a task-specific model that includes the pre-processing layer specially trained to advantageously impute particular data parameters advantageous to the accuracy of the machine learning task performed by the task-specific model. In this regard, embodiments of the present disclosure provide improved attention-based prediction of a probability a data parameter should be imputed, and/or improved performance of a machine learning task via a task-specific model that utilizes a pre-processing layer learning a probability threshold set to improve the accuracy of the machine learning task.

The external computing entities 112a-c, for example, may include and/or be associated with one or more data centers and/or production environments. The data centers, for example, may be associated with one or more data repositories storing data that may, in some circumstances, be processed by the modeling computing entity 102 to provide dashboard(s), machine learning analytic(s), evaluation process(es), and/or the like. Additionally, or alternatively, in some embodiments the external computing entity 112a-c represent production environments. By way of example, the external computing entities 112a-c may be associated with a plurality of distinct entities. A first example external computing entity 112a, for example, may host a registry for the entities. By way of example, in some example embodiments, the entities may include one or more service providers and the external computing entity 112a may host a registry (e.g., the national provider identifier registry, and/or the like) including one or more clinical profiles for the service providers. Additionally, or alternatively, in some embodiments, the external computing entity 112a may include service provider data indicative of medical encounters serviced by the service provider, for example including patient data, CPT and/or diagnosis data, and/or the like. In addition, or alternatively, a second example external computing entity 112b may include one or more claim processing entities that may receive, store, and/or have access to a data set maintained by the entities, for example storing claims data, clinical data, and/or other data that embodies different data portion(s) of a total known data record for one or more identifiers. In this regard, the external computing entity 112b may include one or more data portions embodying any number of data parameters such as patient data, CPT and/or diagnosis data, claims data, other code data, and/or the like for any of several medical encounters. In some embodiments, the external computing entity 112b embodies one or more computing system(s) that support operations of an insurance or other healthcare-related entity. In some embodiments, a third example external computing entity 112c may include a data processing entity that may preprocess the any such stored data generate one or more portions of data processable for any of a myriad of downstream processes, for example one or more particular machine learning tasks. Additionally, or alternatively, in some embodiments, the external computing entities includes an external computing entity embodying a central data warehouse associated with one or more other external computing entities, for example where the central data warehouse aggregates data across a myriad of other data sources. Additionally, or alternatively, in some embodiments, the external computing entities includes an external computing entity embodying a user device or system that collect(s) user health and/or biometric data. Additionally, or alternatively still, in some embodiments, one or more of the external computing entities 112a-c embody a production environment that utilizes a provides access to local and/or cloud-based services for data imputation and/or access to one or any of several task-specific models corresponding to any number of machine learning tasks.

The modeling computing entity 102 may include, or be in communication with, one or more processing elements 104 (also referred to as processors, processing circuitry, digital circuitry, and/or similar terms used herein interchangeably) that communicate with other elements within the modeling computing entity 102 via a bus, for example. As will be understood, the modeling computing entity 102 may be embodied in any of several distinct ways. The modeling computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the modeling computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the modeling computing entity 102 with the assistance of the processing element 104. Additionally, or alternatively, in some embodiments the memory element 106 supports a database of data records embodying portions of data parameters associated with one or more identifiers, a truth source data set or individual portions of truth source data, and/or the like. Additionally, or alternatively, in some embodiments, the memory element 106 supports storing and/or maintaining of one or more task-specific models.

As indicated, in one embodiment, the modeling computing entity 102 may also include one or more communication interfaces 108 for communicating with various computing entities such as the external computing entity 112a-c, such as by communicating data, content, information, and/or similar terms used herein interchangeably that may be transmitted, received, operated on, processed, displayed, stored, and/or the like.

In some embodiments, any of the external computing entity 112a-c may communicate with the modeling computing entity 102 through one or more communication channels using one or more communication networks, for example the communications network 110. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

### III. Example of Certain Terms

“Attention block output” refers to electronically managed data outputted from a set attention block.

“Attention layer” refers to any layer of an attention mechanism associated with a model.

“Data parameter” refers to electronically managed data of a particular classification associated with an identifier, where such data processable for data imputation and/or processable via at least one task-specific model. Non-limiting examples of a data parameter include healthcare code data identified with a particular identifier from any of a myriad of data sources.

“Data set” refers to at least one data structure that stores and/or maintains any number of data objects of one or more data object types. A data set may maintain a particular type of data or maintain a plurality of types of data.

“Identifier” refers to electronically managed data that uniquely identifies a particular entity corresponding to any number of data parameters.

“Imputation model” refers to a statistical, algorithmic, and/or machine learning model that generates probability data representing a likelihood that a particular data parameter should be present in a particular data set.

“Machine learning task” refers to a particular objective associated with a function that is optimized by a particular task-specific model during training.

“Masked data” refers to electronically managed data removed or otherwise hidden from a data set utilizing a masking algorithm.

“Masked data set” refers to a data set including any number of portions of masked data.

“Non-imputed data parameter” refers to a data parameter that is associated with a portion of probability data that does not satisfy a corresponding probability threshold. A non-imputed data parameter is ignored as not present in a particular data set inputted for processing by a task-specific model.

“Parameter data set” and “Data parameter set” refer to a data set including any number of data parameters.

“Pre-processing layer” refers to an initial layer, or combination of sub-layers, of a machine learning model including one or more nodes utilized to generate a probability threshold set corresponding to any number of data parameters.

“Probability data” refers to electronically managed data representing a likelihood that a particular data parameter should be present in a particular data set.

“Probability data set” refers to a data set including any number of portions of probability data.

“Probability threshold” refers to electronically managed data representing a threshold value corresponding to a data parameter that, if not satisfied, indicates the data parameter should not be considered in processing by a task-specific model. In some embodiments, a probability threshold represents a cutoff value that, if not satisfied, indicates the data parameter as a non-imputed data parameter, and that if satisfied indicates that the data parameter is to be imputed based at least in part on the probability data corresponding to that data parameter.

“Probability threshold set” refers to a data set including any number of probability thresholds corresponding to any number of data parameters.

“Set attention block” refers to an attention mechanism comprised of one or more layers that emphasize one or more portions of an input data set embodying a data set of unordered data.

“Task-specific model” refers to any machine learning model specially trained to perform a particular machine learning task. Non-limiting examples of a task-specific model include classification models, prediction models, clustering models, determination models, and regression models.

“Task-specific results” refers to electronically managed data generated by a task-specific model that represents an output associated with a machine learning task.

“Truth source data” refers to electronically managed data representing a data parameter associated with an identifier, where such data is identified from a trusted data source.

“Truth source data set” refers to a data set including any number of portions of truth source data associated with any number of identifiers.

“Updated probability data” refers to a data value representing probability data updated based at least in part on comparison of an initial data value with a corresponding probability threshold.

“Updated truth source data set” refers to a data set generated by masking one or more portions of truth source data from the original truth source data set.

### IV. Overview

Data and data modeling (e.g., via machine learning) is utilized for a myriad of purposes. In various contexts, a data set may be processed associated with a myriad of entities. For example, in the context of healthcare data processing, electronic healthcare records may include plurality of different data codes associated with one or more patients where such data is inputted by a myriad of different healthcare providers, hospitals, and/or other entities. Due to any of a myriad of inefficiencies in data storage and/or sharing, a data set that is received and/or utilized for further processing may be incomplete with respect to a particular identifier by lacking one or more portions of data that should be present in the data set and associated with the particular identifier.

Such inaccuracies in the completeness and/or accuracy of data sets is significant in particular computing processes. For example, when training and utilizing machine learning models for any of a myriad of tasks, accuracy of data sets utilized as a ground truth for training of such models is particularly important to ensure accurate learning is performed by the model. In certain contexts, for example within the context of healthcare data processing, however, the problem of missing data is further exacerbated by the existence of unknown-unknowns. Such contexts are distinct from conventional missing data and/or data imputation contexts in which a data portion is known to be missing but its value is unknown, for example lab test results where it is known that a lab test has been ordered. In a contrary context, it may not be known whether a specific healthcare code is missing from a patient's electronic healthcare record because of an error in data transmission and/or collection or because the healthcare code was appropriately determined not to apply to a patient (e.g., the patient was determined not to have the corresponding disease). In this regard, accurate missingness determinations of unknown data from a data set is to be determined based at least in part on the other available data associated with one or more identifiers.

Problems associated with imputation of unknown-unknown missing data are further compounded in circumstances where imputed data may be utilized in one or more downstream applications. For example, in certain contexts one or more task-specific models may be trained based at least in part on an inputted data set that may benefit from one or more portions of inputted data. In such contexts, however, some such task-specific models may benefit from data imputation where others may not benefit. Additionally, or alternatively, one or more of such task-specific models may not benefit from imputation of all portions of data, but rather may be affected by false imputations that negatively impact the performance of such models with respect to a particular machine learning task. In this regard, additional technical problems exist with respect to predicting whether to utilize imputed data a downstream application, for example with respect to data imputation when training and/or utilizing a particular task-specific model.

Some embodiments of the present disclosure provide for improved data imputation utilizing an improved model. Some such embodiments provide an improved imputation model that embodies a specially-configured neural network that indicates how likely a particular data parameter that is not present in a data set should be present (e.g., and thus should be imputed). The improved imputation model includes a particular set attention block that drives attention towards particular aspects of the inputted data set. Such attention improves the accuracy of the imputation model with respect to unknown-unknown data parameters.

A trained imputation model may be deployed in production to impute data that was not seen during training. It should be appreciated that in various contexts, data parameters associated with a particular identifier may change. For example, continuing the context of electronic healthcare data processing, disease codes corresponding to a patient may change over the course of time as the patient's health changes. Conventional methodologies for tackling distribution shift, including continuous retraining of a model, are either inefficient, time-consuming, costly, or otherwise impractical. In this regard, the inventors have determined that an alternative mechanism for combating such a distribution shift is desired.

Additionally, or alternatively, some embodiments train an improved imputation model utilizing an updated truth source data set generated by applying a stratified masking algorithm to mask one or more portions of a data set for training. By utilizing such a stratified masking algorithm, such embodiments provide a novel regularization technique that considers the sparsity of data and allows for bootstrapping of the training data. Additionally, by masking one or more portions of a truth source data set utilizing the stratified masking algorithm, such embodiments reduce effects of distribution shift, prevent the imputation model from learning arbitrary code-associating rules for imputation, and improve the overall robustness of the imputation model.

Additionally, or alternatively still, some embodiments train task-specific models including one or more specially-configured pre-processing layers utilized in determination of whether particular data parameters are to be imputed. For example, in some embodiments, a pre-processing layer is appended to other task-specific layers of a particular task-specific model, where the pre-processing layer is tuned to adaptively learn probability thresholds. Such probability thresholds are utilized to determine whether to impute a particular data parameter for use in processing via a particular task-specific model. The probability thresholds represented or otherwise derived from the trained pre-processing layer may be utilized to alter whether a particular data parameter is imputed and utilized for further processing in the task-specific model and/or not imputed based at least in part on the probability data corresponding to that particular data parameter and the probability threshold corresponding to the particular data parameter. In this regard, the learned adaptive probability thresholds represented by the pre-processing layer enables a downstream task-specific model to ignore imputations that negatively impact the accuracy of such a model with respect to a particular target machine learning task.

In this regard, embodiments of the present disclosure may be specially configured in any of the aforementioned manners to provide one or more technical solutions to one or more of the technical problems, and/or improve technical solutions to such technical problems.

Other technical improvements and advantages may be realized by one of ordinary skill in the art.

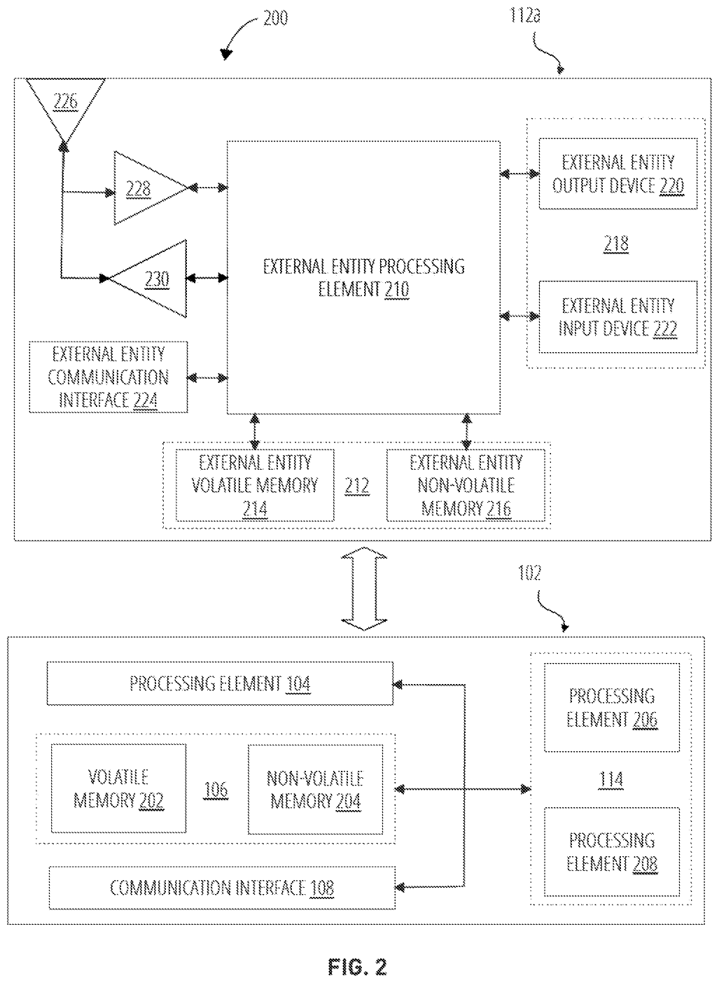

FIG. 2 is a schematic diagram showing a system computing architecture 200 in accordance with some embodiments discussed herein. In some embodiments, the system computing architecture 200 may include the modeling computing entity 102 and/or the external computing entity 112a of the computing system 100. The modeling computing entity 102 and/or the external computing entity 112a may include a computing apparatus, a computing device, and/or any form of computing entity configured to execute instructions stored on a computer-readable storage medium to perform certain steps or operations.

The modeling computing entity 102 may include a processing element 104, a memory element 106, a communication interface 108, and/or one or more I/O elements 114 that communicate within the modeling computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FcRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the modeling computing entity 102 to perform one or more step/operations described herein.

Implementations of the present disclosure may be implemented in many ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created, or modified at the time of execution).

The modeling computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The modeling computing entity 102 may include one or more I/O elements 114. The I/O elements 114 may include one or more output devices embodied at least in part by processing element 206 and/or one or more input devices embodied at least in part by processing element 208 for providing and/or receiving information with a user, respectively. The output devices may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices may include one or more sensory input devices such as one or more tactile input devices (e.g., touch sensitive displays, push buttons, and/or the like), one or more audio input devices (e.g., microphones, and/or the like), and/or the like.

In addition, or alternatively, the modeling computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the modeling computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of several of wireless communication standards and protocols, such as those described above regarding the modeling computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of several input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### V. Example Systems Operations

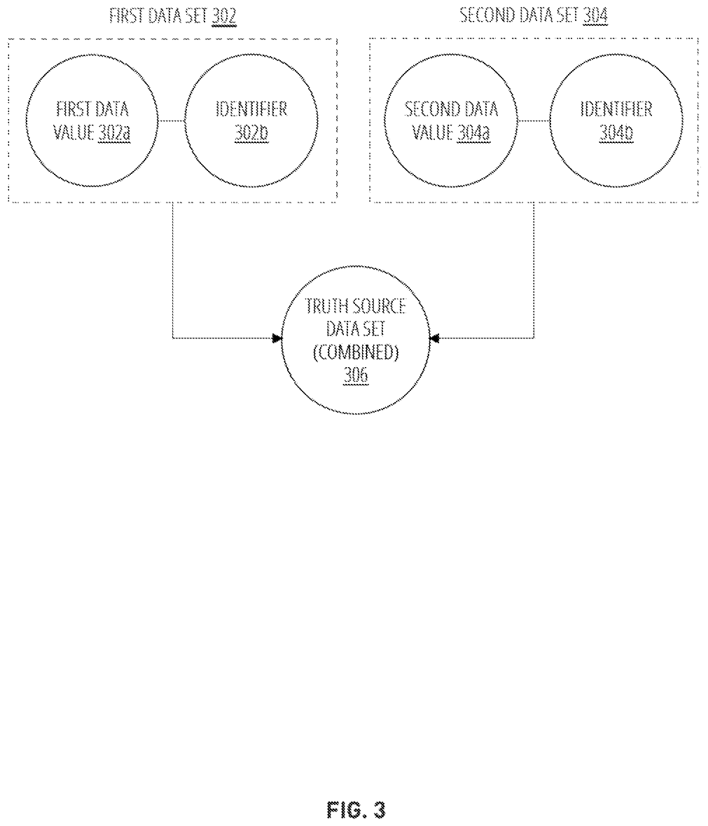

FIG. 3 illustrates an example data flow for generation of an updated truth source data set to be processed in accordance with at least one embodiment of the present disclosure. Specifically, it depicts the generation of an updated truth source data set 310. In some embodiments, the updated truth source data set 310 is generated from a truth source data set 306 for processing.

The truth source data set 306 in some embodiments represents one or more sets of data parameters corresponding to one or more entities. In some embodiments, the truth source data set 306 includes a set of data parameters corresponding to a particular entity. In one example context, the truth source data set 306 includes codes and/or other health data associated with one or more patients, each patient corresponding to a particular identifier. In this regard, in some such contexts the truth source data set 306 embodies one or more electronic health record(s) for one or more patients.

In some embodiments, the truth source data set 306 is formed from one or more sub data sets including any number of different data parameters for any number of identifiers. For example, in some embodiments, the truth source data set 306 embodies a combination of first data set 302 and second data set 304. In some embodiments, the first data set 302 embodies a first data set associated with a first identifier and the second data set 304 embodies a second data set associated with a second data identifier, for example a first patient electronic health record and a second patient electronic health record. Additionally, or alternatively, in some embodiments, the first data set 302 embodies data retrieved from a first data source and the second data set 304 embodies data retrieved from a second data source. For example, in some embodiments the first data set 302 embodies data pulled from one or more centralized storage systems, and the second data set 304 embodies data pulled from one or more edge computers, client devices, and/or the like. In one example context, the first data set 302 embodies electronic health record data (e.g., codes corresponding to each patient of any number of patients) submitted by one or more hospital systems, and the second data set 304 embodies electronic health record data retrieved from a patient health aggregation system. In some embodiments, each data set includes one or more data values each associated with at least one identifier. In some embodiments, each data value represents a particular data parameter for processing and is associated with a particular identifier uniquely identifying an entity associated with that data parameter, such as a patient corresponding to a code. In this regard, in some embodiments the first data set 302, second data set 304, and/or truth source data set 306 represents clinical code information for a particular patient corresponding to a particular identifier, or for each patient of multiple patients that are each identified by a particular, distinct identifier. As illustrated for example, first data set 302 includes one or more first data values 302a each corresponding to an identifier of one or more identifiers 302b, and second data set 304 includes one or more second data values 304a each corresponding to an identifier of one or more identifiers 304b.

In some embodiments, the truth source data set 306 is combined from the first data set 302 and second data set 304 based at least in part on data values associated with one or more identifiers shared between such data sets. For example, some embodiments retrieve the first data set 302 and second data set 304 and process the identifiers to identify multiple data values associated with identifiers of the same values, such that the identifiers embody a single shared identifier. The data values each associated with the same shared identifier may be linked together as a subset in the resulting truth source data set 306, such that the combination of first data set 302 and second data set 304 may be defined by a logical “OR” operation applied to the two data sets with respect to a particular shared identifier. In this regard, in some embodiments the truth source data set 306 includes a plurality of subsets corresponding to a plurality of shared identifiers.

In one example context, the first data set 302 embodies a first set of codes associated with at least one patient and the second data set 304 embodies a second set of codes associated with at least one patient. The distinct set of codes may be retrieved from different systems and/or otherwise constructed from different authorities (e.g., different medical providers and/or facilities), such that the same identifier may be associated with different codes in each of the data sets. The application of such data sets to a logical “OR” operation for shared identifiers between the first and second data sets thus may be used to generate an updated truth source data set, for example embodied by the truth source data set 306, that includes each data parameter identified for a particular shared identifier in either the first data set 302 or the second data set 304, thus forming a more complete data set for the entity (e.g., a patient) corresponding to that particular identifier.

In some embodiments, the truth source data set 306 embodies an updated truth source data set for further processing. For example, in some embodiments, the truth source data set 306 is applied to a trained model as described herein to generate probability data corresponding to each data parameter of any number of data parameters. In this regard, in some embodiments, the truth source data set 306 is processed to determine one or more patterns, learnings, relationships, and/or the like connecting the various data parameters represented by data values in the data set, for example via a trained probability model as depicted and described herein.

Additionally or alternatively, in some embodiments, the truth source data set 306 is further processed via a stratified masking algorithm to augment the truth source data set 306 in a manner that generates an updated truth source data set for further processing. For example, in some embodiments, the truth source data set 306 is applied to a stratified masking algorithm to generate an updated truth source data set that masks an equal proportions between a first stratum of data parameters identified in the truth source data set 306 and a second stratum of data parameters not identified in the truth source data set 306, such that a resulting updated truth source data set is generated as an augmented version of the truth source data set 306 with respect to a universe of possible data parameters. The data parameters masked from each stratum in some embodiments in some embodiments represents masking data, which in some embodiments may be tracked for further processing. It should be appreciated that the use of stratified masking in such a binary data use case, particularly where sparsity of such binary data is high (e.g., most data parameters of the universe of data parameters may not be identified in the truth source data set 306), provides improved accuracy over random masking that would be more likely to mask more from the more-prevalent stratum.

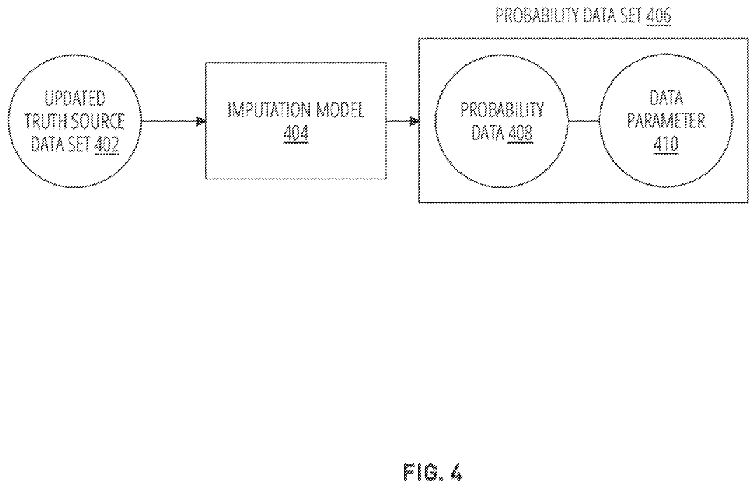

FIG. 4 illustrates an example data flow for generating a probability data set utilizing an imputation model in accordance with at least one embodiment of the present disclosure. Specifically, FIG. 4 depicts generation of a probability data set via a particular imputation model 404. In some embodiments, the updated truth source data set 402 generates a probability data set 406 based at least in part on particular input data, for example, the updated truth source data set 402. In some embodiments, the imputation model 404 is trained utilizing at least one stratified masking algorithm that masks particular data during training to improve robustness of the learned data variables, for example masking in equal proportions from data parameters identified in a ground truth source data set and data parameters not identified in a ground truth source data set. In some embodiments, the stratified masking algorithm does NOT feature during training of the imputation model 404 to augment the truth source data set utilizing at least a masked data set comprising at least one data parameter from a truth source data set and/or at least one data parameter not from the truth source data set.

In some embodiments, the updated truth source data set 402 embodies the updated truth source data set 310 as depicted and described with respect to FIG. 3. In this regard, the updated truth source data set 402 in some embodiments includes one or more data values, each embodying a data parameter associated with a particular identifier. Additionally, or alternatively, in some embodiments, the updated truth source data set 402 includes any number of subsets, each subset including a subset of data parameters associated with the same shared identifier. The updated truth source data set 402 may include a plurality of subsets, each associated with a different shared identifier. In some embodiments, the updated truth source data set 402 is masked such that at least one data parameter is removed from consideration compared to an initial truth source data set. In some embodiments, stratified masking is applied that masks data parameters found in a truth source data set and data parameters not found in a truth source data set with equal proportion for consideration during training.

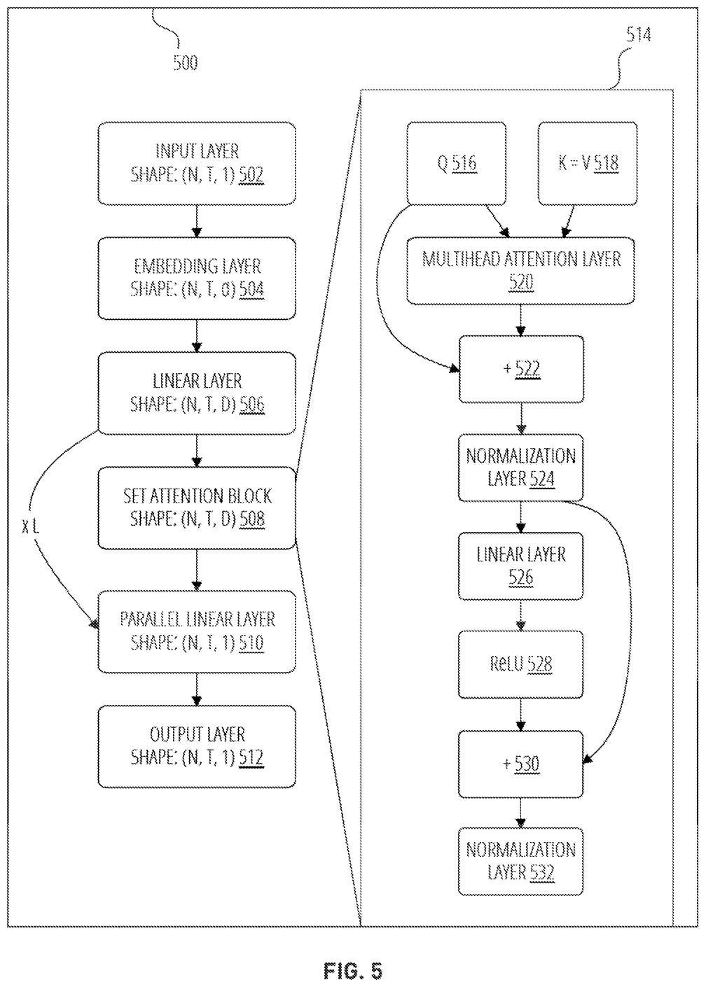

In some embodiments, the updated truth source data set 402 is applied to the imputation model 404. The imputation model 404 in some embodiments embodies a particular machine learning and/or AI model. In some embodiments, the imputation model 404 includes a specially-configured neural network (e.g., a deep neural network, recurrent neural network, and/or other neural network implementation that is trained based at least in part on updated truth source data set 402 as training data). Specifically, in some embodiments, the imputation model 404 embodies a specially-configured set transformer neural network. Additionally, or alternatively, in some embodiments, the imputation model 404 is embodied by the specially-configured neural network depicted and described with respect to FIG. 5. It should be appreciated that in other embodiments, the imputation model 404 is embodied by another model type configured to generate one or more portions of probability data as depicted and described herein.

For example, in some embodiments, the imputation model 404 is trained to generate a value representing a likelihood that a particular data parameter not included in a data set associated with a particular identifier is likely to be present. Specifically, in some embodiments, the imputation model 404 generates a portion of probability data 408 corresponding to a particular data parameter 410. In some embodiments, the probability data 408 for the associated data parameter 410 additionally corresponds to a particular identifier being processed, for example, such that the probability data 408 specifically represents a likelihood that data parameter 410 should be present in the set of data associated with the particular identifier. In this regard, in some embodiments the imputation model 404 generates probability data between 0 and 1, or another defined range, which represents a likelihood that a particular corresponding data parameter should be included associated with a particular identifier. In some embodiments, the imputation model 404 generates a probability data set 406 that includes any number of portions of probability data 408, each portion of probability data corresponding to a different data parameter 410. In some such embodiments, the imputation model 404 generates a probability data set that includes a portion of probability data corresponding to each data parameter that is not included in the updated truth source data set 402 associated with the particular identifier being processed and is identifiable from knowledge base, database, and/or the like defining a plurality of data parameters embodying a universe of data parameters that may be present in a data set associated with a particular identifier.

In some embodiments, the imputation model 404 is trained based at least in part on the input data as a training data set. For example, in some embodiments, the updated truth source data set 402 and/or at least a portion thereof is used to train the imputation model 404. In this regard, the imputation model 404 learns from the updated truth source data set 402 by at least generating the updated truth source data set 402, and comparing a determination of whether the probability data 408 for a particular data parameter 410 indicates that the data parameter 410 should be present for the identifier with whether the data parameter 410 was actually present in an original truth source data set corresponding to the updated truth source data set 402. For example, in some embodiments, the imputation model 404 learns from data patterns, trends, relationships, and/or the like based at least in part on whether the data parameter 410 is present in masked data corresponding to the updated truth source data set 402.

It should be appreciated that, in some embodiments, the imputation model 404 processes updated truth source data set 402 including only data associated with a particular identifier. In this regard, the updated truth source data set 402 may be utilized to generate a particular probability data set 406 corresponding to the particular identifier. Additionally, or alternatively, in some embodiments, the updated truth source data set 402 includes subsets of one or more data portions associated with any number of different identifiers, and the imputation model 404 processes such data to generate the probability data set 406 corresponding to a particular identifier based at least in part on the data for each identifier in the updated truth source data set 402.

In some embodiments, the imputation model 404 generates one or more portions of parameter data representing one or more imputed data parameter. In some embodiments, the imputation model 404 generates the one or more portions of parameter data based at least in part on generated portions of probability data. For example, in some embodiments, the imputation model 404 generates portions of parameter data that satisfies a corresponding threshold, such as a corresponding probability threshold associated with a particular task-specific model. Additionally, or alternatively, in some embodiments, one or more data parameters are generated based at least in part on the probability data generated by the imputation model 404 via an additional process after operation of the imputation model. In some such embodiments, the generated data parameters in some embodiments represent particular imputed data parameters that may be added to a data set for further processing. For example, in some embodiments, imputed data parameters generated by or based at least in part on the output from an imputation model are added to a truth source data set for training, and/or added to a data set representing data parameters associated with one or more particular identifiers in a production environment during use of the imputation model after training.

FIG. 5 illustrates an example data architecture of an imputation model utilizing a set attention block in accordance with at least one embodiment of the present disclosure. Specifically, FIG. 5 depicts an example model 500. The model 500 embodies a specially-configured deep neural network including a particular attention mechanism embodied by a set attention block. The model 500 embodies a transformer model, for example a set transformer, which is configured to process a set of data parameters.

As illustrated, the model 500 embodying the set transformer model receives input at an input layer 502. The input layer 502 is of a shape (N, T, 1). In this regard, N represents a batch size embodying a hyperparameter of the model 500 for training. T represents a number of data parameters to be considered, for example associated with each identifier. In one example context, T represents. For example, in some embodiments, the data parameters embody several codes for each patient represented by a particular identifier. The data parameters may be derived from one or more data sets that, alone or through updating as depicted and with respect to FIG. 3, embodies a truth source data set for processing. During training, the input data set may be an updated truth source data set that includes one or more portions of masked data hidden or otherwise removed from a data set via at least one stratified masking algorithm. In some embodiments, the input data set embodies a particular set of data parameters embodying codes associated with one or more patients, for example ICD and/or other codes pulled from one or more portions of an electronic health record for a patient or electronic health records of a plurality of patients.

Subsequently the model 500 includes an embedding layer 504. The embedding layer 504 is of a shape (N, T, D). In this regard, D represents the hidden dimension of the transformer's hidden layer. The embedding layer 504 embeds the input data set into such a reduced dimension. The model 500 further includes linear layer 506. The linear layer 506 is of a shape (N, T, D). In some embodiments, the linear layer 506 performs a linear function that alters the input tensor to an output tensor of the indicated shape, for example by applying one or more weights and/or biases in a linear operation.

The model 500 further includes set attention block 508. The set attention block 508 embodies a series of layers representing a specially-configured attention mechanism. The set attention block 508 in some embodiments includes any number of repeatable layers, such that after L layers of the set attention block 508 the set attention block generates an attention block output comprising data representing the learned correlations between the T codes of the input data. In this regard, the attention block output may be utilized to identify emphasized portions of the input data (e.g., a data parameter set) that affect the outcome of the model, and/or further processed to emphasize such particular portions of the input data in downstream processes.

The model 500 further includes parallel linear layer 510, the parallel linear layer 510 maps the attention results outputted from the set attention block 508 to a particular dimension. The tensor is of a dimension (T, 1). The model 500 then includes output layer 512. The output layer 512 in some embodiments represents a sigmoid activation function of the same shape as parallel linear layer 510. In some embodiments, the sigmoid activation function outputs a probability corresponding to each particular data parameter of the T data parameters. For example, in some embodiments the output layer 512 generates a probability data set including a portion of probability data corresponding to each data parameter. Each portion of probability data embodies a data value between 0 and 1 that represents a likelihood that the corresponding data parameter should be in the input data set.

As illustrated, the set attention block 508 includes a plurality of sub-layers embodying the attention mechanism. Specifically, as illustrated, the set attention block 508 includes or is embodied by attention layers 514. In some embodiments, the attention layers 514 embodies a transformer model-based self-attention sub-model. It should be appreciated that, in some embodiments, the attention layers 514 includes one or more additional and/or alternative layers as known in the art.

The attention layers 514 includes input layers of a first input vector 516 and a second input vector 518. In some embodiments, the first input vector 516 embodies or includes a query vector. In some embodiments, the second input vector 518 embodies or includes a key vector and/or a value vector. In some such embodiments, the input vectors represented by first input vector 516 and second input vector 518 embody or include the outputs of the linear layer 506 for processing via a multi-head attention layer. Specifically, the first input vector 516 and second input vector 518 are inputted into the multi-head attention layer 520. The multi-head attention layer 520 in some embodiments executes a plurality of attention mechanisms in parallel.

In some embodiments, the results from the multi-head attention layer 520 are outputted to a combination layer 522. In some embodiments, the combination layer 522 embodies or includes a concatenation layer that combines outputs of executions of the multi-head attention layer 520. In other embodiments, the combination layer 522 utilizes another mathematical combination of elements. In some embodiments, the combination layer 522 embodies a different transformation that combines the output of the multi-head attention layer 520.

In some embodiments, the attention layers 514 further include normalization layer 524. The normalization layer 524 normalizes the data values, such as the activations, outputted from the combination layer 522. In some embodiments, the normalization layer 524 embodies a LayerNorm implementation.

In some embodiments, the attention layers 514 further include linear layer 526. The linear layer 526 includes a layer that combines the outputs of the normalization layer 524 into a target dimensionality. The output of the linear layer 526 is then input to the ReLU 528 embodying a rectified linear unit. In some embodiments the ReLU 528 embodies a particular layer implementation as known in the art.

In some embodiments, the output of the ReLU 528 is further processed for recombination and normalization. For example, as illustrated, output from the ReLU 528 is provided to combination layer 530. In some embodiments, the combination layer 530 embodies or includes a concatenation layer that combines outputs of the ReLU 528. In some embodiments, the combination layer 530 embodies a different transformation. It will be appreciated that in some embodiments the combination performed at combination layer 530 is the same combination performed at combination layer 522 utilizing different input data. The output of combination layer 530 is further processed by a normalization layer 532 to perform a final normalization of such data.

In some embodiments, the output of the attention layers 514 are outputted to parallel linear layer 510 as depicted and described. Additionally, or alternatively, in some embodiments, output of the attention layers 514 is processed via a plurality of iterations. For example, in some embodiments, the attention layers 514 are executed for L total iterations, where the L iterations embody the set attention block 508.

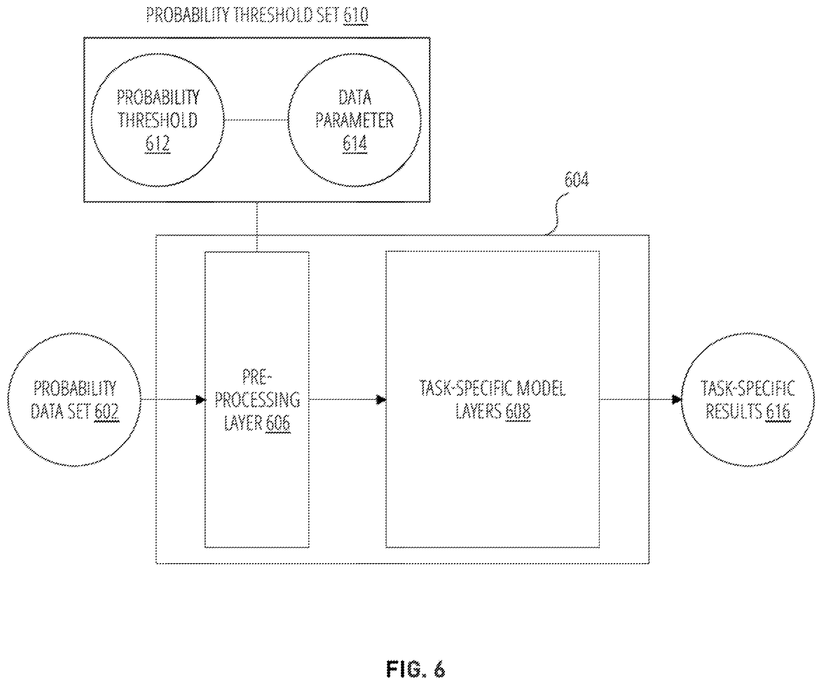

FIG. 6 illustrates an example data architecture of training a task-specific model to generate at least the probability threshold set in accordance with at least one embodiment of the present disclosure. Specifically, FIG. 6 depicts training of a task-specific model 604 to generate a probability threshold set 610 corresponding to the particular task-specific model 604. The task-specific model 604 receives as input at least a probability data set 602. In some such embodiments, the probability data set 602 is embodied by the probability data set 406 as depicted and described with respect to FIG. 4.

In some embodiments, the task-specific model 604 is trained to support a particular machine learning task. In this regard, the task-specific model 604 in some embodiments includes task-specific model layers 608 that generate task-specific results 616 corresponding to the machine learning task. For example, in some embodiments the task-specific model 604 includes task-specific model layers 608 embodying a sub-model, such as a neural network, trained AI, and/or the like. It should be appreciated that in some embodiments the task-specific model layers 608 is embodied by any of a myriad of known machine learning models and/or implementations that support a particular machine learning task.

Additionally, in some embodiments, the task-specific model 604 includes a pre-processing layer 606. In some embodiments, the pre-processing layer 606 is configured to maintain nodes corresponding to a data value representing a probability threshold for a particular data parameter. For example, in some embodiments, the pre-processing layer 606 includes T nodes corresponding to T data parameters of a probability data set, for example the probability data set 602, such that each node corresponds to a particular data parameter. In this regard, each node may be associated with a data value that determines whether a data parameter should be imputed as included in a particular data set that does not currently include it, for example a set of data parameters for a particular identifier to be processed. In this regard, the data value for a particular node corresponding to a particular data parameter may be associated with a particular probability threshold corresponding to the particular data parameter.

In some embodiments, upon completion of training, the pre-processing layer 606 includes or otherwise maintains data values embodying a probability threshold set 610. The probability threshold set 610 includes any number of probability thresholds 612 corresponding to data parameters 614. In this regard, a particular probability threshold 612 of the probability threshold set 610 in some embodiments is represented by a particular data value of a node in the pre-processing layer 606 corresponding to the data parameter 614. In some such embodiments, the probability threshold 612 represents a value within a same defined range as the probability data generated for the data parameter 614, for example between 0 and 1, that represents the threshold for imputing the data parameter 614 corresponding to that probability threshold for processing. During training of the task-specific model 604, the pre-processing layer 606 may adaptively increase the value of a probability threshold corresponding to a data parameter that improves the accuracy of the task-specific results generated by the task-specific model 604, and/or decrease or leave unadjusted the value of a probability threshold that does not improve the accuracy of the task-specific results. For example, each node of the pre-processing layer 606 may be projected to a particular probability threshold 612 for each data parameter 614 corresponding to said node in the pre-processing layer 606.

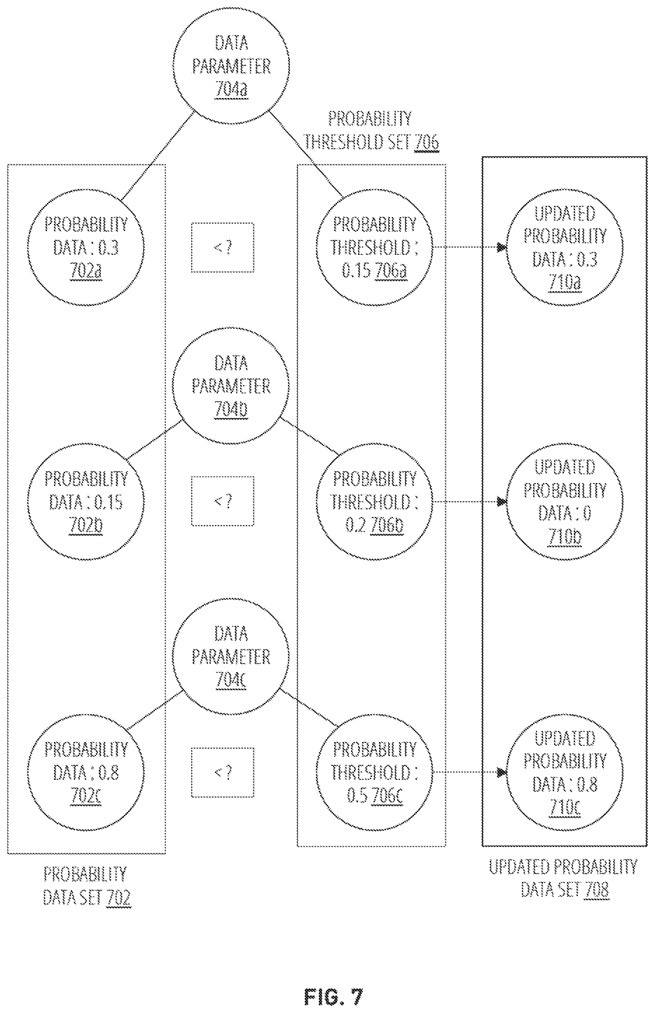

In this regard, the data value embodying the particular probability threshold may be compared to the probability data for the particular data parameter to determine whether the data parameter is to be imputed in a data set for processing. For example, in some embodiments, the probability threshold 612 for a particular data parameter 614 is compared to an input portion of probability data similarly corresponding to the data parameter 614. In some embodiments, during use of the task-specific model 604, in a circumstance where a portion of probability data for a particular data parameter 614 does not satisfy a corresponding probability threshold 612 for the data parameter 614, the portion of probability data is zeroed out or otherwise neutralized (e.g., replaced with a probability of 0.0). Additionally, or alternatively, in some embodiments, in circumstances where the portion of probability data corresponding to the data parameter 614 satisfies the corresponding probability threshold 612 for the data parameter 614, the portion of probability data may be left unaltered for processing by the remaining portion of the task-specific model 604, for example the task-specific model layers 608. For example, in some embodiments the probability data set 602 is updated as depicted and described in FIG. 7. In this regard, the task-specific model 604 may ignore imputations that may be negatively impacting the prediction accuracy by zeroing out such probabilities corresponding to such data parameters. In some embodiments, the pre-processing layer 606 may be pre-pended to the task-specific model layers of any other task-specific model. Additionally, or alternatively, in some embodiments, the pre-processing layer 606 is specific to the task-specific model 604.

In some embodiments, any number of a myriad of downstream task-specific models may be trained. For example, in some embodiments, multiple task-specific models are trained that each correspond to different machine learning tasks. Each of such task-specific models may include a different pre-processing layer that represents and/or adaptively learns different probability thresholds for a plurality of data parameters. Additionally, or alternatively, in some embodiments, a particular pre-processing layer representing particular probability thresholds may be duplicated between multiple task-specific models. It will be appreciated that, in some embodiments, a user may select a particular task-specific model to utilize in a production environment to process particular data, for example where the selection is based at least in part on a particular machine learning model determined to be performed on such data (e.g., in response to user input, an automatic determination, and/or the like that determines the machine learning task).

FIG. 7 illustrates an example data architecture for updating a probability data set based at least in part on at least one probability threshold in accordance with at least one embodiment of the present disclosure. Specifically, FIG. 7 depicts updating of a probability data set 702 to generate a corresponding updated probability data set 708.

In some embodiments, the probability data set 702 includes a plurality of portions of probability data. For example, in some embodiments, the probability data set 702 includes probability data 702a, probability data 702b, and probability data 702c. Each portion of probability data is associated with a different data parameter. For example, probability data 702a is associated with a data parameter 704a, probability data 702b is associated with a data parameter 704b, and probability data 702c is associated with a data parameter 704c. In one example context, the probability data 702a includes probability data that represents a likelihood that a particular code embodying a data parameter should be imputed. In this regard, data imputation of a particular data parameter in some embodiments is performed if and only if probability data corresponding to said data parameter is determined to satisfy (e.g., exceed, or in some embodiments is greater-than-or-equal-to) a probability threshold corresponding to said data parameter.

For example, in some embodiments, each portion of probability data embodies or includes a particular data value that represents the likelihood that the particular corresponding data parameter should be imputed. As illustrated, probability data 702a represents a data value of 0.3 (e.g., a 30% likelihood), probability data 702b represents a data value of 0.15 (e.g., a 15% likelihood), and probability data 702c represents a data value of 0.8. In some embodiments, the probability data set 702 is embodied by the probability data set 602 as depicted and discussed with respect to FIG. 6.

Additionally, or alternatively, in some embodiments, each data parameter is associated with a particular probability threshold corresponding to that data parameter. As illustrated, the data parameters 704a-704c are associated with a probability threshold set 706. For example, as illustrated, the data parameter 704a is associated with a probability threshold 706a, the data parameter 704b is associated with a probability threshold 706b, and the data parameter 704c is associated with a probability threshold 706c. In some embodiments, a probability threshold embodies or includes a data value representing a cutoff of probability for a particular data parameter where the data parameter should be imputed if corresponding probability data satisfies the probability threshold. As illustrated, the probability threshold 706a represents a data value of 0.15 (e.g., a cutoff of a 15% likelihood), probability threshold 706b represents a data value of 0.2 (e.g., a cutoff of a 20% likelihood), and probability threshold 706c represents a data value of 0.5 (e.g., a cutoff of a 50% likelihood). In some embodiments, the probability threshold set 706 is embodied by the probability threshold set 610 as depicted and described with respect to FIG. 6.

In some embodiments, each portion of probability data is compared to the corresponding probability threshold for that portion of probability data. As illustrated, probability data 702a is compared with the corresponding probability threshold 706a for the data parameter 704a, probability data 702b is compared with the corresponding probability threshold 706b for the data parameter 704b, and probability data 702c is compared with the corresponding probability threshold 706c for the data parameter 704c. Some embodiments compare a portion of probability data with a corresponding probability threshold to determine whether the probability data satisfies the corresponding probability threshold. In some embodiments, a portion of probability data satisfies a probability threshold in a circumstance where the value represented by the probability data exceeds, and/or is equivalent or exceeds, the value represented by the corresponding probability threshold. In this regard, a portion of probability data in some embodiments is determined not to satisfy the probability threshold in a circumstance where the value represented by the probability data 702a does not satisfy the value of the corresponding probability threshold.

Some embodiments adjust or otherwise generate updated probability data for each portion of probability data based at least in part on the results of the comparison. For example, in some embodiments, in a circumstance where probability data (representing an original probability data for updating) is determined to satisfy or otherwise exceed a corresponding probability threshold based at least in part on the comparison, corresponding updated probability data is generated having the same, unadjusted value as the original probability data. In some such embodiments, in a circumstance where probability data is determined to satisfy or otherwise falls below a corresponding probability threshold based at least in part on the comparison, corresponding updated probability data is generated having a zeroed-out value (e.g., a value of 0.0). In this regard, the updated probability data indicates that the data parameter corresponding to such updated probability data should not be imputed and thereby not considered as input by the task-specific model.

Continuing the example illustrated in FIG. 7, the 0.3 value of probability data 702a is compared with the 0.15 value of probability threshold 706a. In this regard, the result of the comparison indicates a determination that the probability data 702a satisfies the probability threshold 706a. Similarly, the 0.8 value of probability data 702c is compared with the 0.5 value of the probability threshold 706c. In this regard, the result of the comparison indicates a determination that the probability data 702c satisfies the probability data 702c. Based at least in part on the results of these comparisons, some embodiments skip the updating of the data value of such probability data and generate updated probability data including a data value representing the same data value as the original probability data. For example, updated probability data 710a is generated representing the 0.3 value of the probability data 702a, and updated probability data 710c is generated representing the 0.8 value of the probability data 702c.

The 0.15 value of probability data 702b is compared with the 0.2 value of probability threshold 706b. In this regard, the result of the comparison indicates a determination that the probability data 702b satisfies the probability threshold 706b. Based at least in part on the results of this comparison, some embodiments generate a corresponding updated probability data that is zeroed out. For example, updated probability data 710b is generated representing a 0.0 value regardless of the data value of the probability data 702b. In this regard, the updated probability data 710b representing the value of 0.0 may be utilized for processing by a task-specific model. The data parameter 704b represents a non-imputed data parameter not imputed or considered for purposes of further processing via subsequent layers of the task-specific model.

The updated probability data set 708 in some embodiments is generated including each of the portions of generated updated probability data. For example, as illustrated, the updated probability data set 708 includes updated probability data 710a, updated probability data 710b, and updated probability data 710c. In some embodiments, the updated probability data set 708 is then applied to the remainder of the task-specific model, for example one or more task-specific model layers that support a machine learning task. In this regard, the remaining portions of the task-specific model may operate based at least in part on imputation of particular data parameters associated with a non-zero value of probability data in the updated probability data set 708.

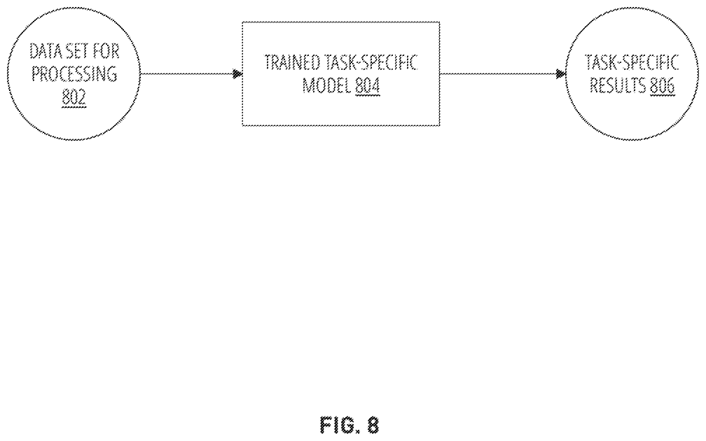

FIG. 8 illustrates an example data flow for utilizing a trained task-specific model in accordance with at least one embodiment of the present disclosure. Specifically, FIG. 8 depicts generation of task-specific results 806 utilizing a trained task-specific model 804. In some embodiments, the trained task-specific model 804 embodies one or more models specially trained as depicted and described with respect to FIG. 6.

In some embodiments, a data set 802 including any number of data parameters is processed as input. In some embodiments, the data set 802 includes data values representing codes in or otherwise associated with a patient represented by a particular identifier. In this regard, in some embodiments the data set 802 includes or otherwise embodies a medical health record associated with a particular identifier. The data set 802 may be received in real-time submitted from an external system, client device, and/or the like, or in some embodiments the data set 802 is received via retrieval from at least one database or other repository.

In some embodiments, the data set 802 is inputted to the trained task-specific model 804 to cause generation of the corresponding task-specific results 806. For example, in some embodiments the trained task-specific model 804 embodies a machine-learning model including the pre-processing layer and as specially trained in accordance with FIG. 3-FIG. 7. In some embodiments, one or more layers of the trained task-specific model 804 perform a machine learning task based at least in part on the data parameters (e.g., existing codes in the data set 802) and/or imputed data values therefrom. In some such embodiments, the data set 802 is processed via a trained imputation model that generates a corresponding probability data set for inputting to the trained task-specific model 804. In some embodiments, the trained task-specific model processes the probability data set 804. For example, in some embodiments, the trained task-specific model 804 processes the probability data set to determine which data parameters to impute based at least in part on the probability data portions in the probability data set corresponding to each data parameter and a probability threshold set learned by nodes of the trained task-specific model 804 in a pre-processing layer. The trained task-specific model 804 may impute one or more data parameters not included in the data set 802 and/or identify one or more non-imputed data parameters not to be imputed based at least in part on the probability threshold set corresponding to a pre-processing layer of the trained task-specific model 804.

The trained task-specific model 804 generates task-specific results 806 that represents determinations, classifications, predictions, and/or other derivations from the data parameters of the data set 802 and/or one or more imputed data parameter. For example, in some embodiments, the trained task-specific model 804 generates task-specific results 806 that represents predictions of whether an identifier, or which identifiers of a set of identifiers, are likely to be associated with a particular data parameter now or at a future timestamp. In one example context, such a prediction represents whether a patient is likely to be associated with a particular diagnosed disease or health state associated with at least one particular code represented by a data parameter. In this regard, utilizing the trained task-specific model 804 that is configured based at least in part on particular probability thresholds, data parameter imputation is performed that more accurately leverages the predictive power of imputing certain data parameters over others for the specific machine learning task associated with the trained task-specific model 804 (e.g., based at least in part on the learned probability threshold set of a pre-processing layer of the trained task-specific model 804).

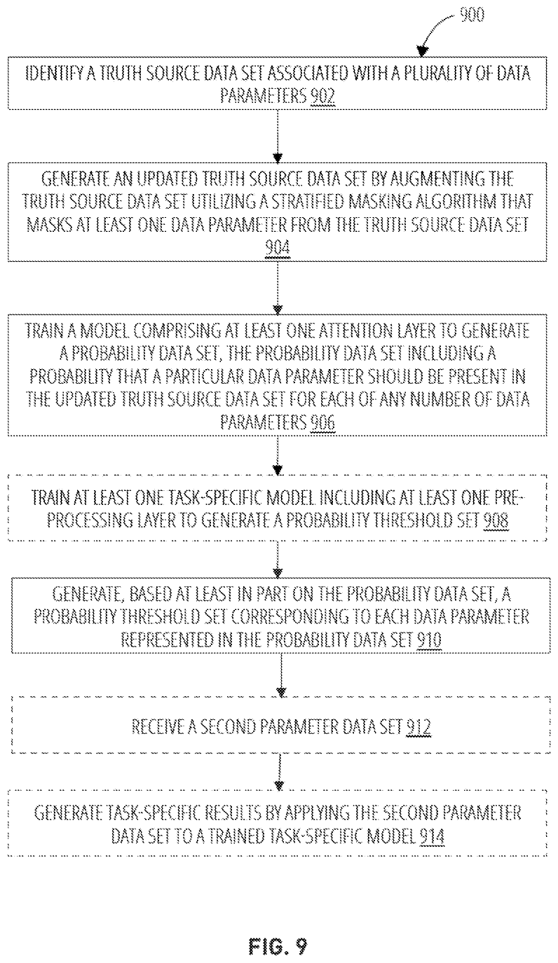

FIG. 9 illustrates a flowchart depicting example operations of a process for generating and using a probability data set for data imputation in accordance with at least one embodiment of the present disclosure. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at the same time or substantially the same time, or in a specific sequence.

The blocks indicate operations of each process. Such operations may be performed in any of several ways, including, without limitation, in the order and manner as depicted and described herein. In some embodiments, one or more blocks of any of the processes described herein occur in between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted blocks are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

FIG. 9 specifically depicts a process 900. The process 900 embodies an example computer-implemented method. In some embodiments, the process 900 is embodied by computer program code stored on a non-transitory computer-readable storage medium of a computer program product configured for execution to perform the process as depicted and described. Alternatively, or additionally, in some embodiments, the process 900 is performed by one or more specially-configured computing devices, such as the specially-configured servers and/or apparatuses depicted and/or described herein alone or in communication with one or more other component(s), device(s), system(s), and/or the like. In this regard, in some such embodiments, such that at least one computing device is specially configured by computer-coded instructions (e.g., computer program instructions) stored thereon, for example in a memory element and/or another component depicted and/or described herein and/or otherwise accessible to the computing device, for performing the operations as depicted and described. In some embodiments, the computing device is in communication with one or more external apparatus(es), system(s), device(s), and/or the like, to perform one or more of the operations as depicted and described. In some embodiments, the computing device is in communication with separate component(s) of a network, external network(s), and/or the like, to perform one or more of the operations as depicted and described. For purposes of simplifying the description, the process 900 is described as performed by and from the perspective of a specially-configured apparatus configured to support a modeling computing entity 102 as depicted and described herein.

According to some examples, the method includes identifying a truth source data set associated with a plurality of data parameters at operation 902. In some embodiments, some or all of the truth source data set is identified via retrieval from at least one database accessible to an apparatus, for example the modeling computing entity 102. Additionally, or alternatively, in some embodiments, some or all of the truth source data set is identified via communication with at least one external device embodying a system that generates, maintains, and/or stores at least a portion of the truth source data set.

In some embodiments, the truth source data set includes any amount of data portions associated with one or more entities. Each data portion in some embodiments embodies or otherwise represents a data parameter associated with a particular entity. In some embodiments, each data parameter embodies a medical claim code, ICD code, or other code of an electronic health record corresponding to a particular patient entity represented by a particular identifier. In this regard, the truth source data set in some embodiments includes codes and/or other data values associated with each patient of any number of patients.

In some embodiments, the truth source data set includes a first subset of truth source data embodying a first data type and a second subset of truth source data embodying a second data type. In some embodiments, each portion of data of the first subset is associated with a particular identifier, and each portion of data associated with the second subset is associated with a particular identifier. In some such embodiments, different data portions associated with a shared identifier may be combined to form the truth source data set for further processing. For example, some embodiments identify a claims data set having one or more portions of claims data each associated with a patient identifier and identify a clinical data set having one or more portions of clinical data each associated with a patient identifier. The claims data set and the clinical data set may be combined by linking claims data associated with a particular shared identifier with clinical data that is similarly associated with that particular shared identifier. It should be appreciated that one or more portions of data in either data set may not be associated with any data portion in the corresponding other data set.

According to some examples, the method includes generating an updated truth source data set at operation 904. In some embodiments, the updated truth source data set is generated by augmenting the truth source data set utilizing a stratified masking algorithm. The stratified masking algorithm masks at least one data parameter from the truth source data set. For example, the stratified masking algorithm may randomly sample in a proportionate manner from one or more subgroups of data parameters, for example a first group embodying data parameters identified in the truth source data set and a second group embodying data parameters not identified in the truth source data set, and mask the sampled data portions representing randomly sampled data parameters accordingly for consideration in an updated truth source data set for a universe of data parameters. In some embodiments, the data masked from the truth source data set may be stored and/or otherwise maintained as a masked data set for further processing.

According to some examples, the method includes training a model at operation 906. In some embodiments, the model includes at least one attention layer. The at least one attention layer generates a probability data set, the probability data set including, for each particular data parameter of one or more data parameters, a probability that a particular data parameter should be present in the updated truth source data set. In this regard, the model may be trained by applying at least a portion of the updated truth source data set as a training data set to the model. The model during such training learns patterns, inferences, and/or other correlations between data parameters in the updated truth source data set and data that was masked from the updated truth source data set, for example as represented in the masked data set generated via applying the stratified masking algorithm to the truth source data set. In some embodiments, the at least one attention layer is embodied by a set attention block as depicted and described herein, for example with respect to FIG. 5 herein.

According to some examples, the method includes training at least one task-specific model at block 908. In some embodiments, each task-specific model is trained to support a particular machine learning task, for example classification(s) of input data, determination(s) based at least in part on input data, prediction(s) based at least in part on input data, and/or the like. In some embodiments, the at least one task-specific model includes at least one pre-processing layer. The pre-processing layer of a particular task-specific model may be configured to represent particular data values that correspond to a threshold for imputation of a particular data parameter. In this regard, in some embodiments, data values of nodes in the pre-processing layer of a particular task-specific model each correspond to a probability threshold for a particular data parameter of the plurality of data parameters. The pre-processing layer may thus enable training of the task-specific model to generate a probability threshold set. In some embodiments each particular task-specific model includes a different pre-processing layer that learns the probability threshold set for that task-specific model during training of that particular task-specific model.

According to some examples, the method includes generating, based at least in part on the probability data set, a probability threshold set corresponding to each data parameter represented in the probability data set at operation 910. In some embodiments, the probability threshold set is generated upon completion of the training for a task-specific model. For example, the probability threshold set in some embodiments is generated based at least in part on the learned data value represented by each node corresponding to a particular data parameter. Accordingly, each particular task-specific model may be associated with a different probability threshold set generated based at least in part on learned data values of the pre-processing layer for the particular task-specific model upon completion of training of each particular task-specific model.

According to some examples, the method includes receiving a second parameter data set at block 912. In some embodiments, the second parameter data set embodies one or more data parameters for a second entity. In one example context, the second parameter data set embodies codes of an electronic health record for a particular patient for processing.

According to some examples, the method includes generating task-specific results by applying the second parameter data set to a trained task-specific model at block 914. In some embodiments, the trained task-specific model is trained to generate task-specific results based at least in part on the inputted second parameter data set. Additionally, or alternatively, in some embodiments, the second parameter data set is applied to a trained first model, for example an imputation model, which generates a second probability data set based at least in part on the second parameter data set. In some embodiments, the second probability data set is applied to the trained task-specific model together with the second parameter data set for use in determining whether to impute a particular data parameter not present in the second parameter data set based at least in part on a comparison between a data value in the second probability data set corresponding to a particular data parameter and the probability threshold in the probability threshold set corresponding to the particular data parameter and task-specific model.

### VI. Conclusion

Embodiments of the present disclosure can be implemented in many ways, including as computer program products that comprise articles of manufacture. Such computer program products can include one or more software components including, for example, software objects, methods, data structures, or the like. A software component can be coded in any of a variety of programming languages. An illustrative programming language can be a lower-level programming language such as an assembly language associated with a particular hardware architecture and/or operating system platform. A software component comprising assembly language instructions can require conversion into executable machine code by an assembler prior to execution by the hardware architecture and/or platform. Another example programming language can be a higher-level programming language that can be portable across multiple architectures. A software component comprising higher-level programming language instructions can require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages can be executed directly by an operating system or other software component without having to be first transformed into another form. A software component can be stored as a file or other data storage construct. Software components of a similar type or functionally related can be stored together such as, for example, in a particular directory, folder, or library. Software components can be static (e.g., pre-established, or fixed) or dynamic (e.g., created or modified at the time of execution).

A computer program product can include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium can include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium can also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium can also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium can also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium can include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media can be substituted for or used in addition to the computer-readable storage media described above.

As should be appreciated, various embodiments of the present disclosure can also be implemented as methods, apparatus, systems, computing devices, computing entities, and/or the like. As such, embodiments of the present disclosure can take the form of an apparatus, system, computing device, computing entity, and/or the like executing instructions stored on a non-transitory computer-readable storage medium to perform certain steps or operations. Thus, embodiments of the present disclosure can also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations can be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code can be performed sequentially such that one instruction is retrieved, loaded, and executed at a time. In some exemplary embodiments, retrieval, loading, and/or execution can be performed in parallel such that multiple instructions are retrieved, loaded, and/or executed together. Thus, such embodiments can produce specially-configured machines performing the steps or operations specified in the block diagrams and flowchart illustrations. Accordingly, the block diagrams and flowchart illustrations support various combinations of embodiments for performing the specified instructions, operations, or steps.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are in various contexts remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, some embodiments of the subject matter have been described. Other embodiments are within the scope of the following claims. In some cases, the actions recited in the claims can be performed in a different order and still achieve desirable results. In addition, the processes depicted in the accompanying figures do not necessarily require the order shown, or sequential order, to achieve desirable results. In certain implementations,

### VII. Examples

Example 1. A computer-implemented method comprising: identifying, by one or more processors, a truth source data set associated with a plurality of data parameters; generating, by the one or more processors, an updated truth source data set by augmenting the truth source data set utilizing a stratified masking algorithm that masks at least one data parameter from the truth source data set; generating, by the one or more processors and using a trained model that comprises at least one attention layer, a probability data set that comprises a particular probability that a particular data parameter should be present in the updated truth source data set; and generating, by the one or more processors and based at least in part on the probability data set, a probability threshold set corresponding to each data parameter represented in the probability data sett.

Example 2. The computer-implemented method of any of the preceding examples, where generating the probability threshold set comprises: training, by the one or more processors, a task-specific model to generate at least the probability threshold set, where the task-specific model comprises at least one pre-processing layer that learns a particular probability threshold for each data parameter of the plurality of data parameters.

Example 3. The computer-implemented method of any of the preceding examples further comprising: determining, by the one or more processors, that the particular probability corresponding to the particular data parameter satisfies the particular probability threshold corresponding to the particular data parameter; and in response to determining that the particular probability threshold is satisfied, skipping, by the one or more processors, updating of the updated probability data.

Example 4. The computer-implemented method of any of the preceding examples, further comprising: determining, by the one or more processors, that the particular probability corresponding to the particular data parameter does not satisfy the particular probability threshold corresponding to the particular data parameter; and generating, by the one or more processors, updated probability data corresponding to the particular probability threshold by updating the probability data corresponding to the particular probability threshold to zero in response to determining that the particular probability will not satisfy.

Example 5. The computer-implemented method of any of the preceding examples, further comprising: applying, by the one or more processors, a second data set to the task-specific model, where the task-specific model is configured to ignore at least one non-imputed data parameter based at least in part on the updated probability data.

Example 6. The computer-implemented method of any of the preceding examples, where the task-specific model is determined based at least in part on a machine learning task determined to be performed.

Example 7. The computer-implemented method of any of the preceding examples, further comprising: training, by the one or more processors, a second task-specific model to generate at least a second probability threshold set, where the second task-specific model comprises at least one second pre-processing layer that learns a second particular probability threshold for each data parameter of the plurality of data parameters; and generating, by the one or more processors and based at least in part on the probability data set, the second probability threshold set corresponding to each data parameter represented in the probability data set.

Example 8. The computer-implemented method of any of the preceding examples, where identifying the truth source data set comprises combining, by the one or more processors, a first set of data and a second set of data based at least in part on identifiers shared between the first set of data and the second set of data

Example 9. The computer-implemented method of any of the preceding examples, further comprising training the trained model by at least: applying, by the one or more processors, at least a subset of the updated truth source data set corresponding to the particular identifier a transformer model.

Example 10. The computer-implemented method of any of the preceding examples, where the at least one attention layer comprises a set attention block comprising a plurality of layers, where at least a subset of the updated truth source data set is processed via the plurality of layers of the set attention block, and where attention block output from the set attention block is provided to a parallel linear block that generates a tensor corresponding to the attention block output.

Example 11. The computer-implemented method of any of the preceding examples, where the tensor is applied to a sigmoid activation function that outputs the probability that the particular data parameter should be present in the updated truth source data set for each data parameter of the any number of data parameters.

Example 12. The computer-implemented method of any of the preceding examples, further comprising: receiving, by the one or more processors, a second parameter data set; and generating task-specific results by applying the second parameter data set to a task-specific model trained based at least in part on the probability threshold set.

Example 13. A system comprising memory and one or more processors communicatively coupled to the memory, the one or more processors configured to perform the computer-implemented method of any one of the preceding examples.

Example 14. One or more non-transitory computer-readable storage media comprising instructions that, when executed by one or more processors, cause the one or more processors to perform the computer-implemented method of any one of the preceding examples.

1. A computer-implemented method comprising:
identifying, by one or more processors, a truth source data set associated with a plurality of data parameters;
generating, by the one or more processors, an updated truth source data set by augmenting the truth source data set utilizing a stratified masking algorithm that masks at least one data parameter from the truth source data set;
generating, by the one or more processors and using a trained model that comprises at least one attention layer, a probability data set that comprises a particular probability that a particular data parameter should be present in the updated truth source data set; and
generating, by the one or more processors and based at least in part on the probability data set, a probability threshold set corresponding to each data parameter represented in the probability data set.

2. The computer-implemented method of claim 1, wherein generating the probability threshold set comprises:
training, by the one or more processors, a task-specific model to generate at least the probability threshold set, wherein the task-specific model comprises at least one pre-processing layer that learns a particular probability threshold for each data parameter of the plurality of data parameters.

3. The computer-implemented method of claim 2, further comprising:
determining, by the one or more processors, that the particular probability corresponding to the particular data parameter satisfies the particular probability threshold corresponding to the particular data parameter; and
in response to determining that the particular probability threshold is satisfied, skipping, by the one or more processors, updating of the particular probability data in an updated probability data set.

4. The computer-implemented method of claim 2, further comprising:
determining, by the one or more processors, that the particular probability corresponding to the particular data parameter does not satisfy the particular probability threshold corresponding to the particular data parameter; and
generating, by the one or more processors, updated probability data corresponding to the particular probability threshold by updating the particular probability data corresponding to the particular probability threshold to zero in response to determining that the particular probability will not satisfy.

5. The computer-implemented method of claim 4, further comprising:
applying, by the one or more processors, a second data set to the task-specific model, wherein the task-specific model is configured to ignore at least one non-imputed data parameter based at least in part on the updated probability data.

6. The computer-implemented method of claim 2, wherein the task-specific model is determined based at least in part on a machine learning task determined to be performed.

7. The computer-implemented method of claim 2, further comprising:
training, by the one or more processors, a second task-specific model to generate at least a second probability threshold set, wherein the second task-specific model comprises at least one second pre-processing layer that learns a second particular probability threshold for each data parameter of the plurality of data parameters; and
generating, by the one or more processors and based at least in part on the probability data set, the second probability threshold set corresponding to each data parameter represented in the probability data set.

8. The computer-implemented method of claim 1, wherein identifying the truth source data set comprises combining a first set of data and a second set of data based at least in part on identifiers shared between the first set of data and the second set of data.

9. The computer-implemented method of claim 1, further comprising training the trained model by at least:
applying, by the one or more processors, at least a subset of the updated truth source data set corresponding to a particular identifier to a transformer model.

10. The computer-implemented method of claim 1, wherein the at least one attention layer comprises a set attention block comprising a plurality of layers, wherein at least a subset of the updated truth source data set is processed via the plurality of layers of the set attention block, and wherein attention block output from the set attention block is provided to a parallel linear block that generates a tensor corresponding to the attention block output.

11. The computer-implemented method of claim 10, wherein the tensor is applied to a sigmoid activation function that outputs the probability that the particular data parameter should be present in the updated truth source data set for each data parameter of the any number of data parameters.

12. The computer-implemented method of claim 1, further comprising:
receiving, by the one or more processors, a second parameter data set; and
generating, by the one or more processors, task-specific results by applying the second parameter data set to a task-specific model trained based at least in part on the probability threshold set.

13. A system comprising memory and one or more processors communicatively coupled to the memory, the one or more processors configured to:
identify a truth source data set associated with a plurality of data parameters;
generate an updated truth source data set by augmenting the truth source data set utilizing a stratified masking algorithm that masks at least one data parameter from the truth source data set;
generate, using a trained model that comprises at least one attention layer, a probability data set that comprises a particular probability that a particular data parameter should be present in the updated truth source data set; and
generate, based at least in part on the probability data set, a probability threshold set corresponding to each data parameter represented in the probability data set.

14. The system of claim 13, wherein to generate the probability threshold set the one or more processors are further configured to:
train a task-specific model to generate at least the probability threshold set, wherein the task-specific model comprises at least one pre-processing layer that learns a particular probability threshold for each data parameter of the plurality of data parameters.

15. The system of claim 14, wherein the one or more processors are further configured to:
determine that the particular probability corresponding to the particular data parameter satisfies the particular probability threshold corresponding to the particular data parameter; and
in response to determining that the particular probability threshold is satisfied, skip updating of the particular probability data in an updated probability data set.

16. The system of claim 14, wherein the one or more processors are further configured to:
determine that the particular probability corresponding to the particular data parameter does not satisfy the particular probability threshold corresponding to the particular data parameter; and
generate updated probability data corresponding to the particular probability threshold by updating the probability data corresponding to the particular probability threshold to zero in response to determining that the particular probability will not satisfy.

17. The system of claim 16, wherein the one or more processors are further configured to:
apply a second data set to the task-specific model, wherein the task-specific model is configured to ignore at least one non-imputed data parameter based at least in part on the updated probability data.

18. The system of claim 14, where the task-specific model is determined based at least in part on a machine learning task determined to be performed.

19. The system of claim 16, wherein the one or more processors are further configured to:
train a second task-specific model to generate at least a second probability threshold set, wherein the second task-specific model comprises at least one second pre-processing layer that learns a second particular probability threshold for each data parameter of the plurality of data parameters; and
generate, based at least in part on the probability data set, the second probability threshold set corresponding to each data parameter represented in the probability data set.

20. One or more non-transitory computer-readable storage media including instructions that, when executed by one or more processors, cause the one or more processors to:
identify a truth source data set associated with a plurality of data parameters;
generate an updated truth source data set by augmenting the truth source data set utilizing a stratified masking algorithm that masks at least one data parameter from the truth source data set;
generate, using a trained model that comprises at least one attention layer, a probability data set that comprises a particular probability that a particular data parameter should be present in the updated truth source data set; and
generate, based at least in part on the probability data set, a probability threshold set corresponding to each data parameter represented in the probability data set.
